(19) United States
(12) Patent Application Publication
(10) Pub. No.: US 2025/0299399 A1
(43) Pub. Date: Sep. 25, 2025

(54) CONTENT SYNTHESIS USING LATENT ADVERSARIAL DIFFUSION DISTILLATION

(71) Applicant: Stability AI Ltd, London (GB)

(72) Inventors: Axel Sauer, London (GB); Frederic Boesel, London (GB); Tim Dockhorn, London (GB); Andreas Blattmann, London (GB); Patrick Esser, London (GB); Robin Rombach, London (GB)

(73) Assignee: Stability AI Ltd, London (GB)

(21) Appl. No.: 19/043,064

(22) Filed: Jan. 31, 2025

Related U.S. Application Data
(60) Provisional application No. 63/567,137, filed on Mar. 19, 2024.

(51) Int. Cl. G06T 11/60

(52) U.S. Cl. CPC G06T 11/60

(57) ABSTRACT

A method including receiving a first representation of an image in a first latent space of a first machine learning model. The method further includes generating, by a second machine learning model based at least in part on the first representation, a second representation of the image in a second latent space of the second machine learning model. The method further includes updating, without generating an output image corresponding to the image, a set of weights of the second machine learning model based at least in part on the first representation and the second representation.

### CROSS-REFERENCES TO RELATED APPLICATIONS

This application is a non-provisional application which claims priority to U.S. Provisional Application No. 63/567,137 filed on Mar. 19, 2024, the contents of which are herein incorporated by reference in their entirety.

### BACKGROUND

Artificial Intelligence (AI) models (e.g., machine learning (ML) models) can be used to generate output based on received natural language input prompts. Some AI models can be used to generate and output content (e.g., images) based on natural language input prompts. For example, a machine learning model may receive a prompt of a user, where the prompt asks the model to “generate an image of a cat napping on a blanket.” In response, the machine learning model may generate an image that depicts a cat napping on a blanket. Such models are trained using various training techniques.

### BRIEF DESCRIPTION OF THE DRAWINGS

Various embodiments in accordance with the present disclosure will be described with reference to the drawings, in which:

FIG. 1 illustrates an example of using a content generation system, according to certain embodiments of the present disclosure;

FIG. 2 illustrates an example of a content generation system, according to certain embodiments of the present disclosure;

FIG. 3 illustrates an example of a system for training a machine learning model in a latent space, according to certain embodiments of the present disclosure;

FIG. 4 illustrates an example of a system for training an encoder model and/or a decoder model, according to certain embodiments of the present disclosure;

FIG. 5 illustrates an example of a process for using a content generation system, according to certain embodiments of the present disclosure;

FIG. 6 illustrates an example of a process for training an encoder model and/or a decoder model, according to certain embodiments of the present disclosure;

FIG. 7 illustrates an example of a process for training a student diffusion transformer model, according to certain embodiments of the present disclosure;

FIG. 8 illustrates an example of a process for training a student diffusion transformer model, according to certain embodiments of the present disclosure; and

FIG. 9 is a simplified block diagram illustrating an example architecture of a system used to train and/or use the models and systems described herein, according to certain embodiments of the present disclosure.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Challenges exist relating to machine learning (ML) models, both during training and inference. Embodiments described herein can improve how machine learning models (e.g., reverse diffusion transformer models) are trained and used for inference.

Training machine learning models presents several challenges, many of which stem from issues related to data. One primary challenge is the limited availability of high-quality, real-world data for training purposes. In many cases, the prompts and/or content (e.g., images, text, code, audio, video, etc.) required to train a model may be scarce (e.g., has already been used for training, exists in limited quantities), incomplete, and/or difficult to access due to privacy and/or proprietary concerns. To address this, synthetic data including artificially generated datasets that mimic real-world data can be highly beneficial, as it allows for the creation of diverse and scalable datasets. Further synthetic data can be obtained using fewer resources compared to some techniques for obtaining real-world data. Furthermore, synthetic data can be generated without using information that may have been obtained from other data sources, sensitive data sources, and/or private data sources, etc. However, even when data is available, it often requires curation to ensure it is clean, relevant, and properly labeled for the task at hand. This curation process can be labor-intensive, requiring significant time, resources, and energy to organize, preprocess, and annotate. Additionally, ensuring that the data is adequately representative of the problem domain adds another layer of complexity. These challenges highlight the need for innovation for generating synthetic data that can be used for training machine learning models.

In certain cases, data for training reverse diffusion models often includes curated prompts and curated training images to compare output against and/or generate noise using. Certain embodiments described herein provide techniques for generating data for training reverse diffusion models with or without the use of curated prompts and/or curated training images. Certain embodiments disclosed herein can be configured to initialize a latent representation of content (e.g., an image, text, audio, etc.) in a vector space, without having to first encode the content or a prompt into the vector space. Additionally, embodiments can enable a for training a reverse diffusion model without comparing data outside of a latent space. For example, latent representations of content can be generated for training and compared during training without decoding the latent representations of content into the content (e.g., an image). These techniques can reduce the resources (e.g., energy, processing, memory, network, time, etc.) used during training of the reverse diffusion transformer.

The embodiments can result in using less memory during training, because content and/or prompts may not need to be stored or encoded. The embodiments can result in less energy being used, less network resources, less energy resources, and less time being used, because content and/or prompts may not need to be gathered, stored, and/or encoded. The benefits enabled by embodiments describes herein can quickly compound as training machine learning models often involves large amounts of data and many training iterations/epochs.

Training a model to generate content faster and/or with less computational resource utilization provides significant advantages for client devices, or other devices that use the model. First, the model can enhance user experience by reducing latency, allowing real-time or near-instantaneous image generation. This can be particularly valuable in applications such as augmented reality (AR), virtual reality (VR), gaming, e-commerce, and/or design tools, where users often expect low latency interactions. Faster processing also enables the use of models in resource-constrained environments, such as mobile devices, IoT devices, or edge computing scenarios (e.g., computing by a user device instead of by a server), where hardware capabilities may be limited compared to high-performance servers. Enabling the model to be run in resource-constrained scenarios can reduce the need to use a server to run the model and thereby reduce the amount of data being transmitted over a network (e.g., reducing latency and bandwidth usage) and/or improve security (e.g., because data may not be transmitted over the network).

By optimizing the computational efficiency of the model, users can enjoy high-quality outputs without the need for expensive or power-intensive hardware. Since less energy, power, and/or memory resources may be used by devices that run the model or send and receive requests to or from the model, the devices may have improved battery life and/or improved power consumption. Further, the devices may use less battery, memory, and/or processing materials, thereby making the device lighter and/or use less materials.

Additionally, reduced computational requirements translate into lower energy consumption, which is critical for battery-powered devices like smartphones and tablets. This not only extends device battery life but also aligns with broader sustainability goals by minimizing energy usage. For businesses deploying these models on client devices, the reduced need for high-end hardware lowers entry costs for end-users, broadening the accessibility of the technology. Furthermore, efficient models decrease reliance on cloud-based processing, reducing bandwidth demands and enhancing privacy by enabling more on-device processing. In sum, a faster, resource-efficient machine learning model improves performance, accessibility, and sustainability, benefiting both end-users and organizations deploying the technology.

A benefit of certain embodiments described herein may include improvements to noise level specific feedback. For example, by adjusting parameters of a noise sampling distribution, embodiments can gain direct control over discriminator model behavior, aligning with the standard practice of loss weighting in diffusion model training.

Certain embodiments described herein also provide benefits for using generative machine learning models at inference time. For example, reverse diffusion models, a subclass of generative models, can use an iterative sampling processes to generate content by reversing a diffusion process, or in other words, to generate content by denoising noisy latent representations of the content. When a reverse diffusion model is designed to perform fewer sampling steps compared to another model, it can offer several benefits in terms of efficiency and practicality. First, reducing the number of sampling steps can decreases the computational time required to generate outputs. This can translate to faster inference times, which can be particularly advantageous in real-time applications or resource-constrained environments. Additionally, fewer sampling steps can reduce the computational burden on hardware, leading to lower energy consumption, an important consideration for large-scale and/or environmentally conscious deployments.

Moreover, fewer steps can simplify the overall model architecture, potentially making it easier to train and deploy. This reduction in sampling steps may be carefully balanced to maintain the quality and fidelity of the generated content. Embodiments described herein can be configured to use a first (e.g., a “teacher”) reverse diffusion transformer to train a second (e.g., a “student” reverse diffusion transformer). The second reverse diffusion transformer may use fewer sampling steps than the first reverse diffusion transformer, while maintain comparable quality and fidelity of the first reverse diffusion transformer. Additionally, the second reverse diffusion transformer may include fewer parameters, while maintain comparable quality and fidelity of the first reverse diffusion transformer.

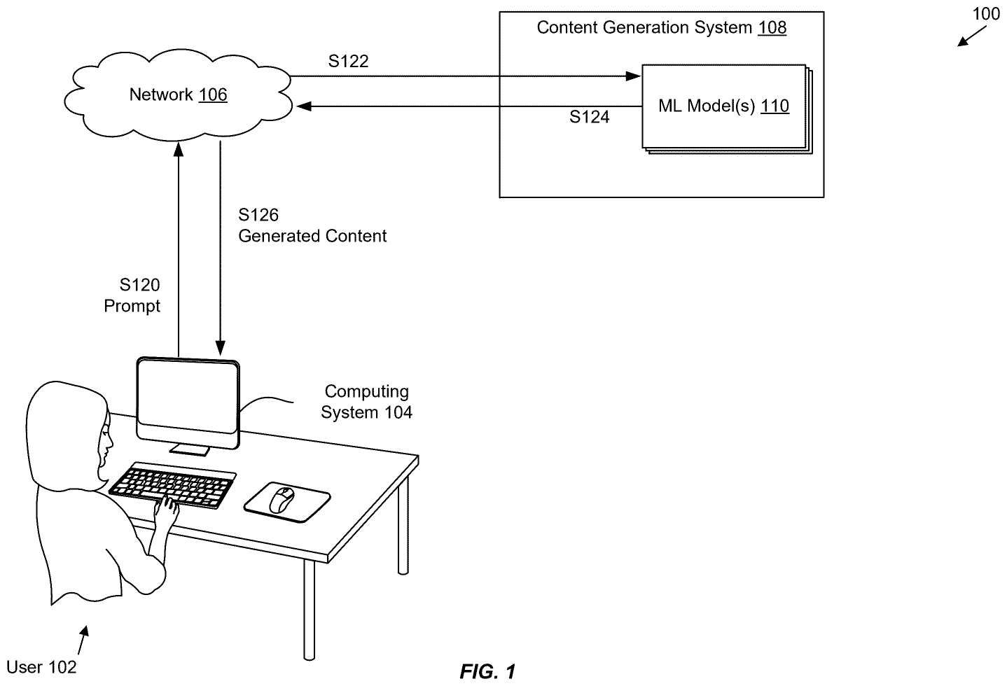

FIG. 1 illustrates an example of using a content generation system 108, according to embodiments of the present disclosure. The content generation system 108 may be used as part of a content creation system 100. The content creation system 100 may include a computing system 104, a network 106, and the content generation system 108. The content generation system 108 may receive a prompt (e.g., a natural language prompt) from the computing system 104 that causes content to be generated using one or more machine learning (ML) models 110. The generated content may be transmitted to the computing system 104 and presented by a user interface.

The computing system 104 may be a user device (e.g., a laptop, a personal computer, a phone, etc.). The computing system 104 may be a server. The computing system 104 may be capable of receiving input from a user 102 via, for example, a user interface. In certain embodiments, the input received by the computing system 104 includes the prompt. The input may cause the computing system 104 to transmit the prompt to the content generation system 108 (e.g., via the network 106). As an example, a user interface of the computing system 104 may receive a natural language prompt (e.g., from user 102) that describes desired characteristics of content to be included in generated content, and the natural language prompt may be transmitted to the content generation system 108 via the network 106.

The prompt may include text (e.g., natural language text) that describes desired characteristics of content to generate such as one or more images, videos, texts, etc. The characteristics may describe a style, a color, a subject, a mood, a texture, a contrast, a depth, a movement, a saturation, a focus, a perspective, a narrative, a format, and/or another characteristic to be included in generated content. The prompt may include at least one of a text, an audio, an image, and/or a video. In some embodiments, text may describe a scene (e.g., a scene from a book or a script) that can then be used to generate content that corresponds to the text. In some embodiments, audio, image(s), and/or a video(s) can be included in the prompt to cause the content generation system 108 to generate content corresponding to the audio, image(s), and/or video(s). For example, a portion of an image may be included in the prompt and content may be generated that includes the portion or similar characteristics as the portion. In another example, a video scene from a movie may be included in the prompt and content may be generated by the content generation system 108 that includes similar characteristics (e.g., similar style, colors, subjects, mood, texture, contrast, depth, movement, saturation, focus, perspective, narrative, etc.) as the portion. In another example, a functional description of code may be included in the prompt and content (e.g., HTML, JavaScript, SQL, Python, etc.) may be generated by the content generation system 108 that produces the described functionality.

The prompt or other information from computing system 104 may include information to determine one or more encoders to use. In an example, encoders used to encode the prompt can be predetermined and constant during runtime. In an example, the prompt may explicitly state which encoders to use or set of encoders to use. In yet another example, the information included in the prompt may be used by content generation system 108 to determine one or more encoders and/or one or more set of encoders to use to encode the prompt or a portion of the prompt.

The prompt may be used as input to the content generation system 108 to cause content to be generated. The content generation system 108 may use a set of one or more machine learning models 110 to generate the content using the prompt. The set of one or more machine learning models 110 may include one or more encoder models, a decoder model, and/or a latent diffusion model (e.g., a diffusion transformer model). Training and using such models are described in further detail herein.

The generated content may include characteristics defined by the prompt. The content may include an image or a video. The generated content may have one or more predefined characteristics. For example, the content may have a predefined size (e.g., pixel dimensions, pixel count, bit size), a predefined max size. The content generation system 108 may transmit the generated content to the computing system 104 for presentation (e.g., for display, for presenting as a downloadable file).

By using the computing system 104 to present the content to the user 102, the user 102 may view the content. Computing system 104 may store the content in memory, send the content to another computing system (e.g., social media application, a different user device, etc.). In some embodiments, subsequent prompts may be received (e.g., from computing system 104 or another computing system) by the content generation system 108 to cause the content generation system 108 to alter the generated content.

The network 106 may be configured to connect the computing system 104 and the content generation system 108, as illustrated. The network 106 may be configured to connect any combination of the system components. In certain embodiments, the network 106 is not part of the content creation system 100. For example, the content generation system 108 may run locally on the computing system 104 and/or one or more of the set of ML models 110 may run locally on computing system 104.

Each of the network 106 data connections can be implemented over a public (e.g., the internet) or private network (e.g., an intranet), whereby an access point, a router, and/or another network node can communicatively couple the computing system 104 and the content generation system 108. A data connection between the components can be a wired data connection (e.g., a universal serial bus (USB) connector), or a wireless connection (e.g., a radio-frequency-based connection). Data connections may also be made through the use of a mesh network. A data connection may also provide a power connection. A power connection can supply power to the connected component. The data connection can provide for data moving to and from system components. One having ordinary skill in the art would recognize that devices may be communicatively coupled through the use of a network (e.g., a local area network (LAN), wide area network (WAN), etc.). Further devices may be communicatively coupled through a combination of wired and wireless means (e.g., wireless connection to a router that is connected via an ethernet cable to a server).

The interfaces between components communicatively coupled with the content creation system 100, as well as interfaces between the components within the content creation system 100, can be implemented using web interfaces and/or application programming interfaces (APIs). For example, the computing system 104 can implement a set of APIs for communications with the content generation system 108, and/or user interfaces of the computing system 104. In an example, the computing system 104 uses a web browser during communications with the content generation system 108.

The content creation system 100 illustrated in FIG. 1 may further implement the illustrated steps S120-S126. The illustrated steps may be implemented by executing instructions stored in a memory of the content creation system 100, where the execution is performed by processors of the content creation system 100.

At step S120, a prompt may be transmitted from the computing system 104 to the network 106. The prompt may include information received from a user interface of the computer system 104. For example, user 102 may have typed: “Please create an image of an old rusted robot wearing pants and a jacket riding skis in a supermarket” and the prompt may reflect the entered information and be transmitted to the network 106.

At step S122, the prompt may continue to be transmitted to the content generation system 108 from the computing system 104 via the network 106. After the content generation system 108 receives the prompt, the content generation system 108 may use the one or more machine learning models 110 to generate the content using the prompt.

At step S124, the content generation system 108 may transmit the generated content to the network 106.

At step S126, the network 106 may transmit the generated content to the computing system 104. Upon the computing system 104 receiving the generated content, the computing system 104 may present the generated content or portions thereof using the user interface of computing system 104. For example, computing system 104 may present an image, a video, and/or text on a display which is viewable by user 102.

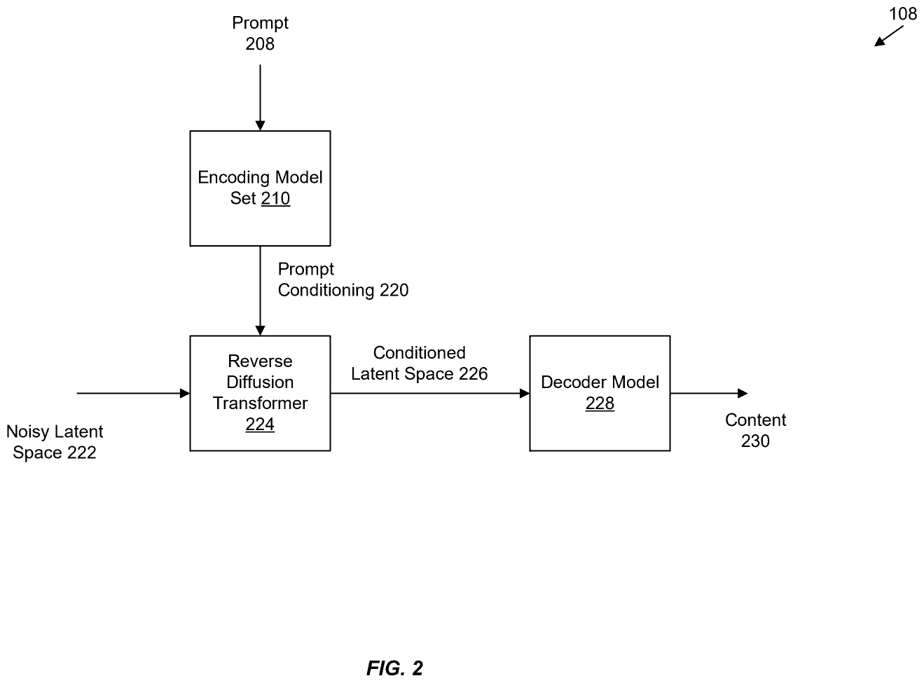

FIG. 2 illustrates an example of a content generation system 108, according to embodiments of the present disclosure. The content generation system 108 may be the content generation system 108 described with respect to FIG. 1. The content generation system 108 may be configured to receive a prompt 208 and output content 230. The content generation system 108 may include an encoding model set 210 of one or more encoding models, a reverse diffusion transformer 224, and a decoder model 228. The encoding model set 210 may include one or more prompt encoding models and may include a timestep encoding model.

The prompt 208 may be transmitted from a computing system (e.g., computing system 104, described above). Prompt 208 may be received from a system (e.g., via a network). Prompt 208 may be received by a user interface of the system. Prompt 208 may describe the desired characteristic of content to be generated by the content generation system 108. For example, a size (e.g., pixel dimensions, pixel count, bit size), a style, a color, a subject, a mood, a texture, a contrast, a depth, a movement, a saturation, a focus, a perspective, a narrative, etc. Prompt 208 may be received by the one or more prompt encoding models of the encoding model set 210.

A prompt encoding model in the encoding model set 210 may be configured to represent prompt 208 or a portion of prompt 208 in a multi-dimensional space (e.g., a vector space, a latent space, etc.). The prompt encoding model may include neural network layers to convert prompt 208 or a portion of prompt 208 into a prompt encoding in the multi-dimensional space. The neural network layers used to generate the prompt encoding may be referred to as embedding layers. The prompt encoding model may be configured and/or previously trained to generate encodings for prompts that are represented as text, audio, an image, and/or video. The prompt encoding model may be a joint image and text encoding model (e.g., a Contrastive Language-Image Pre-Training (CLIP) model), a text encoder from a CLIP model, a large language model, a T5 model, a convolutional neural network transformer, or a recurrent neural network. One of ordinary skill in the art with the benefit of the present disclosure would recognize other ML models that may be used for prompt encoding.

The encoding model set 210 may include one or more prompt encoding models. The prompt encoding models may include one or more frozen prompt encoding models (e.g., trainable model attributes are preserved). The encoding model set 210 used to encode prompt 208 or a portion of prompt 208 may be determined based on prompt 208. For example, the encoding model set 210 used to encode prompt 208 or a portion of prompt 208 may be determined based on instructions in prompt 208 (e.g., to use a specific set of prompt encoding models). In an example, the encoding model set 210 used to encode prompt 208 or a portion of prompt 208 may be determined based on information included in prompt 208 (e.g., prompt includes text, prompt includes text and image, prompt includes audio, etc.). The encoding model set 210 used to encode prompt 208 or a portion of prompt 208 may be predefined (e.g., by a system administrator). The encoding model set 210 used to encode prompt 208 or a portion of prompt 208 may be determined based on instructions received from a computing system.

In some embodiments, prompt 208 or a portion of prompt 208 is received by the encoding model set 210. A first subset of prompt encoding models of the encoding model set 210 may include one or more prompt encoding models to generate an encoding of at least a portion of prompt 208. The encodings generated by the first subset of prompt encoding models may be combined (e.g., via concatenation) into a single vector space and transmitted to the reverse diffusion transformer 224 as prompt conditioning 220. The encoding model set 210 may include one or more of the same prompt encoding models (e.g., a CLIP model). A second subset of the encoding model set 210 may include one or more prompt encoding models to generate an encoding of at least a portion of prompt 208. The generated encodings from the second subset of encoding model set 210 may be combined (e.g., via concatenation) into a single vector space represented by prompt conditioning 220. The prompt conditioning 220 vector space may have a dimensionality that is the same as a dimensionality of a noisy latent space 222 input to reverse diffusion transformer 224.

In certain embodiments, a timestep encoding model is used to encode one or more timesteps (e.g., based at least one a function, a neural network, etc.). The timestep may represent a timestep of the reverse diffusion process. The timestep encoding model may encode the timestep using a neural network and/or encode the timestep based on a function. For example, a timestep encoding model may use a sinusoidal function to determine an encoded timestep based on the timestep. The output of the sinusoidal function may be represented in a vector space as an encoded timestep. The vector space of the encoded timestep may have the same dimensionality as prompt conditioning 220. Embodiments described herein may enable the reverse diffusion transformer 224 to be trained by a teacher reverse diffusion transformer. The reverse diffusion transformer 224 may be trained to use less timesteps than the teacher reverse diffusion transformer.

Time conditioning may be used by a modulation attention mechanism of reverse diffusion transformer 224 and can enable conditional generation. In certain embodiments, time conditioning may be given a higher weight when the timestep used to generate the time conditioning is closer to the middle of a time window compared to other timesteps further away from the middle (e.g., is an intermediate time step).

Reverse diffusion transformer 224 may receive time conditioning, prompt conditioning 220, and/or noisy latent space 222 as input. Reverse diffusion transformer 224 may use the inputs to generate a conditioned latent space 226. Noisy latent space 222 may be a latent space that includes randomly generated noise. Noisy latent space 222 may be generated based on sampling values according to a distribution (e.g., a gaussian distribution). Noisy latent space 222 may be generated based on a seed. The seed may be input to the content generation system 108 (e.g., via a user interface). Noisy latent space 222 may be stored in memory and used by reverse diffusion transformer 224.

Noisy latent space 222 may include positional information. In some embodiments, noisy latent space 222 is generated by adding a positional embedding to an initial noisy latent space. The initial noisy latent space may have been generated using techniques described above with respect to noisy latent space 222. The initial noisy latent space may represent a pixel encoding, a text encoding, etc. The positional embedding can add information about the position of elements in the noisy latent space 222. The positional embedding can help the reverse diffusion transformer 224 understand relative positions and relationships between different parts of an image, text, or other content.

Reverse diffusion transformer 224 may be a machine learning model trained to generate a conditioned latent space (e.g., conditioned latent space 226) using a noisy latent space (e.g., noisy latent space 222). Techniques for training reverse diffusion transformer 224 are described in further detail herein. The conditioned latent space 226 may be generated using a combination of prompt conditioning 220, time conditioning, and/or a noisy latent space 222, etc. The noisy latent space may be generated based on a latent representation generated by a teacher reverse diffusion transformer. The latent representation generated by a teacher reverse diffusion transformer may include synthetic training data.

Reverse diffusion transformer 224 may generate conditioned latent space 226 by removing noise from noisy latent space 222. Reverse diffusion transformer 224 may iteratively remove noise from noisy latent space 222 over timesteps (e.g., 1 timestep, 4 timesteps, more than 4 timesteps) to obtain the conditioned latent space 226. Reverse diffusion transformer 224 may use one or more transformer blocks to generate conditioned latent space 226. Conditioned latent space 226 can be considered to be an encoded/latent form of content (e.g., a latent form of the generated content 230). Conditioned latent space 226 may be stored in memory of content generation system 108.

Decoder model 228 may receive conditioned latent space 226 as input and use conditioned latent space 226 to generate the content 230. Decoder model 228 may be trained using techniques described further herein. Decoder model 228 may be configured to receive conditioned latent space 226 after conditioned latent space 226 is output from reverse diffusion transformer 224. Decoder model 228 may include neural network layers that are used to generate content from an encoding of content (e.g., conditioned latent space 226). Decoder model 228 may include a recurrent neural network, a long short term memory network, a transformer model, a convolutional neural network, or another model architecture. One of ordinary skill in the art with the benefit of the present disclosure would recognize other architectures that may be used for decoder model 228.

Reverse diffusion transformer 224 can be used for image editing. For the image editing task instruction-based editing may be performed. Certain embodiments condition on the input image via channel-wise concatenation and train on paired data with edit instructions. The embodiments may use the synthetic InstrucPix2Pix dataset, for which the original 5122 pixel samples may be upsampled (e.g., using SDXL). Additional data may be used from bidirectional controlnet tasks (e.g., canny edges, keypoints, semantic segmentation, depth maps, and/or HED lines, etc.) as well as object segmentation. During sampling, certain embodiments may guide the edit model with a nested classifier-free guidance formulation, which can allow utilization of different strengths for the image and text conditioning.

For image inpainting, certain embodiments can condition on the masked input image. Different masking strategies can be used, such as narrow strokes, round cutouts, rectangular cutouts, and/or outpainting masks, etc. Furthermore, certain embodiments may condition on the input image during training and inference, omitting the text conditioning for the unconditional case. This configuration may differs from that used in the editing task described above, where the nested classifier-free guidance may be used. For distillation, certain embodiments can use the same LADD hyperparameters as for the editing model. Certain embodiments may not employ synthetic data for this task, and may use an additional distillation loss to improve text-alignment.

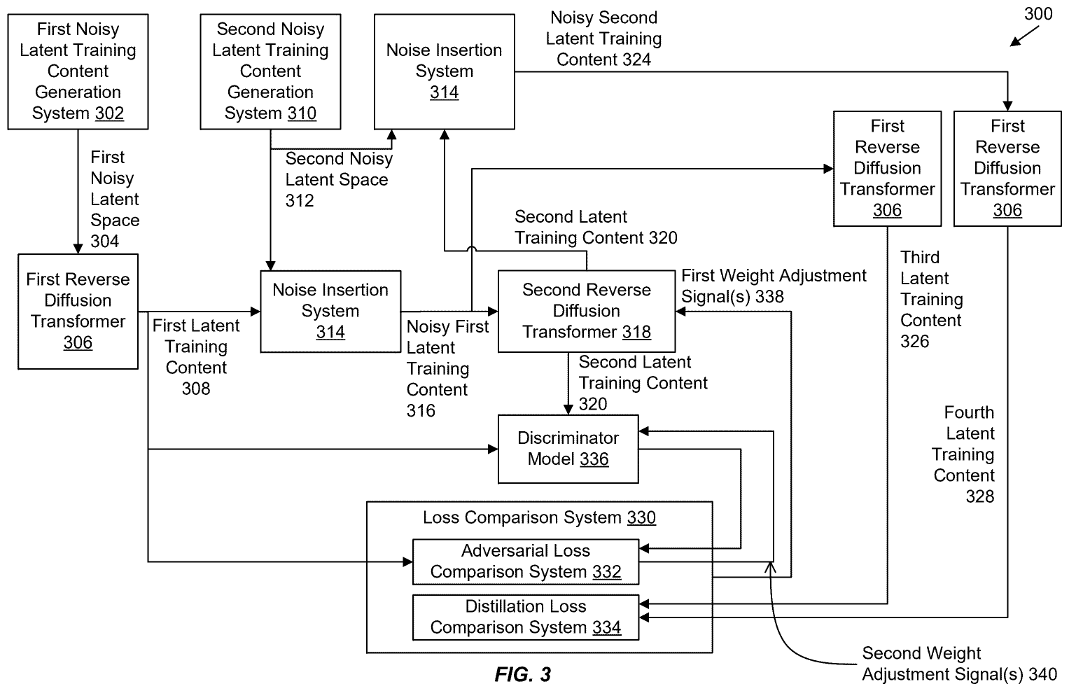

FIG. 3 illustrates an example of a system 300 for training a machine learning model in a latent space, according to certain embodiments of the present disclosure. The system 300 can be used to train a student machine learning model (e.g., also referred to as a second reverse diffusion transformer model 318 herein) using a trained teacher model (e.g., also referred to as a first reverse diffusion transformer model 306 herein). System 300 can simplify training of the second reverse diffusion transformer model 318, enhancing performance of the second reverse diffusion transformer model 318 compared to the first reverse diffusion transformer model 306 and can enable high-resolution multi-aspect ratio image synthesis. The second reverse diffusion transformer model 318 may be configured to use fewer sampling steps than the first reverse diffusion transformer model 306, reducing the processing performed between receiving a prompt and generating content (e.g., going from noise to content) while achieving similar output as the first reverse diffusion transformer model 306. In certain embodiments, the first reverse diffusion transformer model 306 may also occupy more memory than the second reverse diffusion transformer model 318 (e.g., because of using more parameters and/or weights) and/or use more energy during inference time (e.g., because of using more processing steps between noise to content).

System 300 can enable training to occur in the latent space, reducing the need of latent space content (e.g., a latent representation of an image) being decoded into content (e.g., the image). Distillation in latent space can allow for leveraging large student and teacher networks and avoids expensive decoding to pixel space (or other content space such as text space), enabling high-resolution image synthesis. Consequently, system 300, including a Latent Adversarial Diffusion Distillation (LADD) reverse diffusion model training technique, results in a significantly simpler training setup than adversarial diffusion distillation (ADD) while outperforming prior single-step approaches.

System 300 may include a first noisy latent training content generation system 302, the first reverse diffusion transformer 306, a second noisy latent training content generation system 310, a noise insertion system 314, the second reverse diffusion transformer 318 (e.g., the reverse diffusion transformer model 224 described above), a discriminator model 336, and/or a loss comparison system 330. System 300 illustrates multiple noise insertion systems 314 and first reverse diffusion transformers 306 for the simplicity of illustration. The same noise insertion system 314 and first reverse diffusion transformer 306 can be used. In certain embodiments, the same noise insertion system 314 and/or first reverse diffusion transformer 306 are not used, which may enable processing to be performed in parallel.

The first noisy latent training content generation system 302 may generate a first noisy latent space 304. The first noisy latent training content generation system 302 may randomly generate the first noisy latent space 304. The random generation may use a seed, a function, an encoder, a distribution (e.g., a Gaussian distribution), etc. The first noisy latent training content generation system 302 may generate the first noisy latent space 304 using a forward diffusion transformer model, adding noise to content (e.g., an image).

The first noisy latent training content generation system 302 may generate first noisy latent space 304 before training of the second reverse diffusion transformer 318 occurs. Generating the first noisy latent space 304 before training of the second reverse diffusion transformer 318 can preserve time and resources during training of the second reverse diffusion transformer 318. The first noisy latent space 304 may or may not have been used to train the first reverse diffusion transformer 306.

The first reverse diffusion transformer 306 may be the teacher model. The first reverse diffusion transformer 306 may have been previously trained by a “teacher-teacher” model. The first reverse diffusion transformer 306 may have been trained using another training technique. The first reverse diffusion transformer 306 may include one or more frozen weights that are not changed during training of the second reverse diffusion transformer 318. In certain embodiments, the first reverse diffusion transformer 306 may include one or more frozen weights that are changed during training of the second reverse diffusion transformer 318 (e.g., based on signals from the discriminator model 336) so that the first reverse diffusion transformer 306 is further trained to improve synthetic data generation (e.g., generation of first latent training content 308).

The first reverse diffusion transformer 306 may receive a noisy representation of a latent space (e.g., the first noisy latent space 304). The noisy representation may be a latent space representation of content with added noise. The first reverse diffusion transformer 306 may receive the noise from the first noisy latent training content generation system 302 and/or the noise insertion system 314.

The first reverse diffusion transformer 306 may receive a prompt and generate an encoding of the prompt (e.g., using a prompt encoder such as a prompt encoder included in encoding model set 210, described above). In certain embodiments, the first reverse diffusion transformer 306 may receive an encoding of the prompt. The prompt may be received from a set of predefined prompts. The prompt may be received from a set of randomly generated prompts. The prompt may be generated before or during training. The prompt encoding may have been generated by a prompt encoder. In certain embodiments, a prompt encoding is generated in a latent space and without encoding a prompt. The prompt encoding may have been generated in a latent space using a distribution and/or a function.

The prompt encoding may have been generated prior to training the second reverse diffusion transformer 318, which may reduce resources used during training and/or decrease time to train the second reverse diffusion transformer 318. By generating the prompt encoding prior to training the second reverse diffusion transformer 318, processing, networking, and energy resources used during training can be reduced compared to if the prompt encoding was generated at training time. Further, precomputing the prompt encoding and storing the precomputed prompt encoding can reduce the need for recomputing the prompt encoding during subsequent training of the second reverse diffusion transformer 318 or another model. The prompt may describe a desired characteristic of an image. The image may be the content encoded into the latent space and represented by the first latent training content 308.

The prompt encoding and the noisy representation of a latent space (e.g., the first noisy latent space 304) can be used by the first reverse diffusion transformer 306 to generate latent content (e.g., first latent training content 308). The latent content may be generated by the first reverse diffusion transformer 306 using a set of attention blocks included in transformer blocks of the first reverse diffusion transformer 306. The transformer blocks may use the noisy representation of a latent space and the prompt encoding to generate the latent content.

For example, the first reverse diffusion transformer 306 can generate the first latent training content 308 using the prompt encoding and the first noisy latent space 304. As another example, the first reverse diffusion transformer 306 can generate a third latent training content 326 using the prompt encoding and a noisy first latent training content 316 (e.g., generated by adding noise to the first latent training content 308). The first latent training content 308 may be transmitted from the first reverse diffusions transformer 306 to the noise insertion system 314 and/or the discriminator model 336. The first latent training content 308 may include a first representation of content (e.g., an image) described by the prompt or represented by the prompt encoding of a prompt that describes the content.

As another example, the first reverse diffusion transformer 306 can generate the third latent training content 326 using the prompt encoding and the noisy first latent training content 316. The noisy first latent training content 316 can be generated by adding noise to a first latent training content 308 generated by the first reverse diffusion transformer 306 and is described further below. In certain embodiments, the third latent training content 326 is generated using the first latent training content 308 and the second latent training content 320 (e.g., instead of generating the third latent training content 326 using the first reverse diffusion transformer 306).

As yet another example, the first reverse diffusion transformer 306 can generate a fourth latent training content 328 using the prompt encoding and a noisy second latent training content 324. The noisy second latent training content 324 can be generated by adding noise to a second latent training content 320 generated by the second reverse diffusion transformer 318.

The first reverse diffusion transformer 306 may include attention blocks. Respective attention blocks included in the first reverse diffusion transformer 306 may generate respective token sequences. A respective token sequence can be transmitted to a respective corresponding discriminator head included in the discriminator model 336. In certain embodiments, multiple discriminator heads are included (e.g., one to one correspondence for each attention block) in the discriminator model 336.

The second noisy latent training content generation system 310 may receive one or more inputs that the first noisy latent training content generation system 302 can receive. The second noisy latent training content generation system 310 may perform similar processing as the first noisy latent training generation system 302 to generate a second noisy latent space 312. The second noisy latent space 312 may include noise sampled from a distribution (e.g., a Gaussian distribution) in a latent space. The second noisy latent space 312 generated by the second noisy latent training content generation system 310 may be transmitted to the noise insertion system 314.

The noise insertion system 314 may add noise to a latent representation. For example, the noise insertion system 314 may add noise to a latent representation of content. The noise insertion system may add noise to a received latent representation. Noise insertion system 314 may receive the first latent training content 308 from the first reverse diffusion transformer 306. In certain embodiments, noise insertion system 314 may add noise to a latent space by performing vector operations on the latent space. One having ordinary skill in the art with the benefit of the present disclosure would recognize other techniques for adding noise to a latent space. In certain embodiments, the noise insertion system included a forward diffusion model that introduces noise to a latent space.

In certain embodiments, the second noisy latent space 312 may be added to the first latent training content 308 (e.g., a first representation of an image in a first latent space of the first reverse diffusion transformer 306) to generate the noisy first latent training content 316. The noise insertion system 314 may transmit the noisy first latent training content 316 to the second reverse diffusion transformer 318 and/or the first reverse diffusion transformer 306.

In certain embodiments, the second noisy latent space 312 may be added to the second latent training content 320 (e.g., a first representation of an image in a first latent space of the first reverse diffusion transformer 306) to generate the noisy second latent training content 324. The noise may be represented as a noise vector and, the noise vectors added to the second latent training content 320 and the first latent training content 308 may be equivalent noise vectors. The noise insertion system 314 may transmit the noisy second latent training content 324 to the first reverse diffusion transformer 306.

In certain embodiments, the noise insertion system 314 is included in the first noisy latent training content generation system 302 and/or the second noisy latent training content generation system 310.

The second reverse diffusion transformer 318 may be included in the student model. The second reverse diffusion transformer 318 may include a same or different architecture than the first reverse diffusion transformer 306. The second reverse diffusion transformer 318 may include fewer weights and/or parameters than the first reverse diffusion transformer 306. The second reverse diffusion transformer 318 may include one or more weights that are not frozen so that they can change during training of the second reverse diffusion transformer 318 and zero or more weights that are frozen so that they do not change during training of the second reverse diffusion transformer 318. In certain embodiments, the second reverse diffusion transformer 318 attempts to remove the second noisy latent space 312 added by the noise insertion system 314 to the first latent training content 308. The resulting second latent training content 320 generated by the denoising performed by the second reverse diffusion transformer 318 can be compared with the first latent training content 308 or further processed to determine a loss and update the second reverse diffusion transformer 318.

Before the second reverse diffusion transformer 318 can be used during inference time, second reverse diffusion transformer 318 may first be trained to reverse noise introduced by the noise insertion system 314. Noise insertion system 314 may introduce noise into first latent training content 308 to generate noisy first latent training content 316 so that second reverse diffusion transformer 318 can learn how to reverse the noise introduced by noise insertion system 314. Noise insertion system 314 uses first latent training content 308 generated by first reverse diffusion transformer 306. First latent training content 308 may be considered to be a ground truth for training purposes. First latent training content 308 may include synthetic latent training content. Noise insertion system 314 may generate a progressively noisier noisy first latent training content 316 and passes the generated noisy first latent training content 316 to second reverse diffusion transformer 318 to undo the added noise and attempt to obtain the first latent training content 308 from the noisy first latent training content 316. Noise insertion system 314 may add noise to the first latent training content 308 by sampling from a Gaussian distribution to get a vector of the same size as first latent training content 308, then may interpolate between the first latent training content 308 and the second noisy latent space 312 based on coefficients derived from a sampled timestep value.

The encoded timestep may be generated by a timestep encoding model (e.g., included in the encoding model set 210) based on a timestep. Timesteps may be sampled in a non-uniform manner. In certain embodiments, timesteps are sampled with a higher frequency between a starting timestep and an ending timestep. For example, sampling timesteps may follow near a normal distribution or a logit-normal distribution. Timesteps and the timestep encoding model have been described in further detail herein. By sampling with a higher frequency in the middle steps compared to early and late steps where the reverse diffusion process is very hard or very easy, the generated output may be more accurate (e.g., more accurately reflect the prompt).

The noisy first latent training content 316 generated by noise insertion system 314 may also be used as input to second reverse diffusion transformer 318 to train second reverse diffusion transformer 318 to generate second latent output content 320 based on noisy first latent training content 316. Second reverse diffusion transformer 318 may use the encoded prompt conditioning, the time conditioning, and/or the noisy first latent training content 316 to learn to recognize how the encoded prompt corresponds to the first latent training content 308 that was used to generate the noisy first latent training content 316. Second reverse diffusion transformer 318 may use the encoded prompt conditioning and the time conditioning to perform conditioning (e.g., cross attention conditioning, self-attention conditioning). The learning/training may be performed over many iterations. Over the iterations, parameter weights of second reverse diffusion transformer 318 may be adjusted using first weight adjustment signals 338 from the loss comparison system 330.

The second reverse diffusion transformer 318 may receive a noisy representation of a latent space. The noisy representation may be a latent space representation of content with added noise. The second reverse diffusion transformer 318 may receive the noise from the noise insertion system 314. The noisy representation received by the second reverse diffusion transformer 318 may include the noisy first latent training content 316 representation generated by adding noise to the first latent training content 308.

The second reverse diffusion transformer 318 may receive the prompt and/or the prompt encoding that was received and/or generated by the first reverse diffusion transformer 306 and use the prompt and/or prompt encoding to generate the first latent training content 308. The second reverse diffusion transformer 318 may use the prompt, the prompt encoding, and/or the noisy first latent training content 316 to generate the second latent training content 320 (e.g., which may be similar, close, or not close in vector space to the first latent training content 308). The second reverse diffusion transformer 318 may include one or more transformer blocks that are used to generate the second latent training content 320 using the noisy first latent training content 316 and the prompt encoding. The second reverse diffusion transformer 318 can thereby generate the second latent training content 320 based at least in part on the first latent training content 308. The second latent training content 320 generated by the second reverse diffusion transformer 318 may be transmitted to the noise insertion system and/or the discriminator model 336.

The second reverse diffusion transformer 318 may be updated (e.g., weights adjusted, etc.) based at least in part on the second latent training content 320 being compared to content encoding(s) generated by the first reverse diffusion transformer, such as the first latent training content 308, the third latent training content 326, and/or the fourth latent training content 328. The update(s) to the reverse diffusion transformer 318 may be performed without having to decode the latent space representation of content into content (e.g., an image) so that it can be compared using a loss function to a corresponding training ground truth content.

The updates may be performed based on comparisons performed by the loss comparison system 330. Second reverse diffusion transformer 318 may perform the update(s) responsive to receiving a weight adjustment signal. The weight adjustment signal may be received from the loss comparison system. The weight adjustment signal may include one or more first weight adjustment signals 338.

The discriminator model 336 may be included in a generative adversarial network (GAN) for training the second reverse diffusion transformer 318. A GAN is a deep learning architecture. The GAN trains two neural networks, the second reverse diffusion transformer 318 and discriminator model 336, to compete against each other.

The second reverse diffusion transformer 318 and the discriminator model 336 train in an adversarial game, where the second reverse diffusion transformer 318 tries to generate second latent training content 320 and the discriminator model 336 attempts to predict if the second latent training content is fake/second latent training content 320 or real first latent training content 308. Real first latent training content 308 may include a latent representation of content. The real first latent training content 308 may be a latent representation of content generated by the first reverse diffusion transformer 306. The discriminator model 336 can analyze the first latent training content 308 and distinguish between the attributes of the second latent training content 320 generated by the second reverse diffusion transformer 318. The discriminator model 336 can generate the prediction of which of the second latent training content 320 (“fake”) and the first latent training content 306 (“real”) is real and fake. The real/fake prediction can be transmitted to the loss comparison system 330 for generating weight adjustment signal(s).

After the second reverse diffusion transformer 318 generates the second latent training content 320, the second reverse diffusion transformer 318 can transmit the generated second latent training content 320 to the discriminator model 336. The discriminator model 336 calculates the probability that the second latent training content 320 is the ground truth data compared to the first latent training content 308 (e.g., the ground truth data). The discriminator model 336 may be conditioned on the noise level (e.g., the second noisy latent space 312) and the prompt encoding.

Respective attention blocks included in the first reverse diffusion transformer 306 may generate respective token sequences. The respective token sequences can be transmitted to a respective corresponding discriminator head included in the discriminator model 336. In certain embodiments, multiple discriminator heads are included in the discriminator model 336 (e.g., one to one correspondence for each attention block).

In certain embodiments, for the discriminator model 336 architecture, instead of utilizing 1D convolution, the token sequence is reshaped back to its original spatial layout, and transitioned to 2D convolutions. Switching from 1D to 2D convolutions can circumvent a potential issue in the Multi-Aspect Ratio (MAR) setting, where a 1D discriminator could process token sequences of varying strides for different aspect ratios, potentially compromising its efficacy. Since the teacher reverse diffusion model is trained on MAR data, it can inherently generate relevant features for the discriminator heads in in this setting.

In certain embodiments, the discriminator model 336 receives the noisy second latent training content 324 and the first latent training content 308 to predict if the second latent training content is fake/noisy second latent training content 324 or real first latent training content 308. In certain embodiments, the discriminator model 336 receives the noisy second latent training content 324 and the noisy first latent training content 316 to predict if the second latent training content is fake/noisy second latent training content 324 or real noisy first latent training content 316.

The loss comparison system 330 may include loss functions to generate weight adjustment signals, such as the first weight adjustment signal(s) 338 and/or the second weight adjustment signal(s) 340. The loss comparison system 330 may include an adversarial loss comparison system 332 and/or a distillation loss comparison system 334. The adversarial loss comparison system 332 can be used to generate the first weight adjustment signal(s) 338 and/or the second weight adjustment signal(s) 340. The distillation loss comparison system 334 can be used to generate the first weight adjustment signal(s) 338 (e.g., in combination with the adversarial loss comparison system 332). In certain embodiments, the first weight adjustment signal(s) 338 include a summation (e.g., summed vector value) of the adversarial loss computed by the adversarial loss comparison system 332 and the distillation loss computed by the distillation loss comparison system 334.

The first latent training content 308 (e.g., ground truth) and the output of the discriminator model 336 may be used by the adversarial loss comparison system 332 to determine how to adjust the weights of the second reverse diffusion transformer 318 and/or the discriminator model 336. Adversarial loss comparison system 332 may transmit a first weight adjustment signal 338 to the second reverse diffusion transformer 318 to cause one or more weights of the second reverse diffusion transformer 318 to be updated with the goal of reducing the error of the second reverse diffusion transformer 318. The loss comparison system 330 may transmit a second weight adjustment signal to the discriminator model 336 to cause one or more weights of the discriminator model 336 to be updated with the goal of reducing the error of the discriminator model 336.

The adversarial loss comparison system 332 can give some guidance to the second reverse diffusion transformer 318 by performing a weight adjustment to parameters of the second reverse diffusion transformer 318 using a first weight adjustment signal 338 to reduce the noise vector randomization in the next cycle. The second reverse diffusion transformer 318 attempts to maximize the probability of mistake by the discriminator model 336, but the discriminator model 336 attempts to minimize the probability of error using the adversarial loss comparison system 332 that transmits the second weight adjustment signal 340 to the discriminator model 336 to update the weights used by the discriminator model 336. In training iterations, both the second reverse diffusion transformer 318 and discriminator model 336 have their weights changed based on the weight adjustment signals transmitted by the adversarial loss comparison system 332 and are caused to evolve and confront each other continuously. Training iterations may continue until the second reverse diffusion transformer 318 and the discriminator model 336 reach an equilibrium state. In the equilibrium state, the discriminator model 336 may no longer recognize second latent training content 320. At this point, the training process may be complete.

Loss comparison system 330 may transmit the first weight adjustment signals 338 and the second weight adjustment signals 340 with the goal of minimizing the loss functions. The loss can be used to generate gradients to train the transformer(s) during back propagation.

In certain embodiments, the GAN is a basic GAN architecture where second reverse diffusion transformer 318 generates second latent training content 320 with little or no feedback from the discriminator model 336. In certain embodiments, GAN is a conditional GAN architecture where second reverse diffusion transformer 318 and discriminator model 336 receive additional information, such as prompt encodings, time encodings, and/or some other form of conditioning data. One of ordinary skill in the art with the benefit of the present disclosure would recognize other GAN architectures that may be used to train the second reverse diffusion transformer 318 (e.g., a deep convolutional GAN, a Super-resolution GAN, etc.).

The distillation loss comparison system 334 can compare the third latent training content 326 and the fourth latent training content 328 using a distillation loss function. The distillation loss comparison system 334 can compute loss using a mean squared error (MSE) function. One having ordinary skill in the art with the benefit of the present disclosure would recognize other loss functions that may be used by the distillation loss comparison system 334.

The first weight adjustment signal(s) 338 enable the loss comparison system to update the second reverse diffusion transformer 318 (e.g., weights of the model, etc.) without generating output content (e.g., an image) corresponding to the first latent training content 308. The updated second reverse diffusion transformer 318 can thereby be based at least in part on the first latent training content 308 and the second latent training content 320.

After second reverse diffusion transformer 318 has been trained by system 300, second reverse diffusion transformer 318 may be used during inference time, such as illustrated and described with respect to system 200.

In certain embodiments, training is performed across four discrete timesteps t∈[1, 0.75, 0.5, 0.25]. For two step inference, certain embodiments evaluate the model at t∈[1, 0.5]. At higher resolutions (>5122 pixels), an initial warm-up phase can be crucial for training stability; thus, certain embodiments may start with lower noise levels (initial probability distribution p=[0, 0, 0.5, 0.5]). After 500 iterations, the focus may shifts towards full noise (p=[0.7, 0.1, 0.1, 0.1]) to refine single-shot performance. The MAR training may follow a binning strategy.

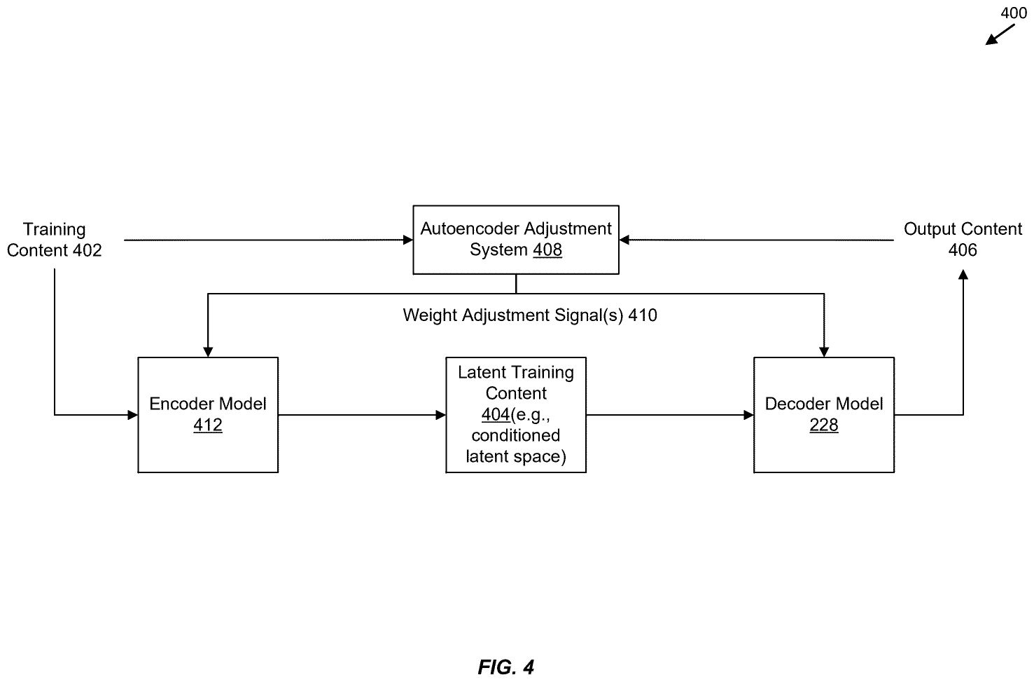

FIG. 4 illustrates an example of a system 400 for training an encoder model (e.g., encoder model 416) and/or a decoder model (e.g., decoder model 228), according to embodiments of the present disclosure. System 400 may include an encoder model 416, the decoder model 228, and an autoencoder adjustment system 408. Decoder model 228 and/or encoder model 416 may be trained by using the autoencoder adjustment system 408 to compare ground truth training content 402 to output content 406 generated by decoder model 228 and adjusting weights of the encoder model 416 and/or the decoder model 228 based on the comparison. Through training iterations, the decoder model 228 can learn to generate accurate output content 406 using latent training content 404. Latent training content 404 may have the same dimensions as a conditioned latent space (e.g., conditioned latent space 226, latent output content 426) generated by reverse diffusion transformer models described with respect to FIGS. 1-3, above, so that the decoder model 228 can generate content 230 using the conditioned latent space 226 generated by reverse diffusion transformer 224.

Encoder model 416 may have been trained and/or be trained by system 400 to generate an embedding of the ground truth training content 402. Training content 402 may be an image, a video or other content. Training content 402 may include the training content (e.g., in a pixel space) used for training described above. Encoder model 416 may process training content 402 by a series of convolutional blocks, each of which performs downsampling. All convolutions may be parameterized in a weight-normalized form. Encoder model 416 may map an input into a lower dimensional space. Increasing a number of latent channels can improve reconstruction performance. The reconstruction quality of encoder model 416 may provide an upper bound on achievable image quality after latent diffusion training. As an example, the number of latent channels may be equal to 16 and achieve an improvement over an encoder model that uses 8 channels. The numbers of channels may also be balanced while considering that a lower number of channels may enable the model to use less resources.

Diminishing returns can exist as the latent channels are increased.

Latent training content 404 generated by encoder model 416 may be transmitted to decoder model 228 to be used as input to decoder model 228. Decoder model 228 may be trained by system 400 to output generated output content 406 (e.g., in a pixel space) based on latent training content 404 (e.g., an encoding of the ground truth training content 402). Output content 406 may include an image, a video, or other content. The architecture of decoder model 228 may be similar to the architecture of encoder model 416, but employ upsampling blocks.

The autoencoder adjustment system 408 can use output content 406 and training content 402 (a ground truth) to determine weight adjustment signals 410 to send to encoder model 416 and/or decoder model 228. Autoencoder adjustment system 408 may compare the output content 406 and training content 402 using a loss function. In some embodiments, a reconstruction loss function is used. Based on the comparison of output content 406 and training content 402 using the loss function, autoencoder adjustment system 408 may transmit the weight adjustment signals 410 to encoder model 416 and/or decoder model 228 with the goal of reducing the loss function. In some embodiments, an adversarial loss term is used by the autoencoder adjustment system 408, utilizing a convolutional discriminator model. The discriminator model may include hyperparameters.

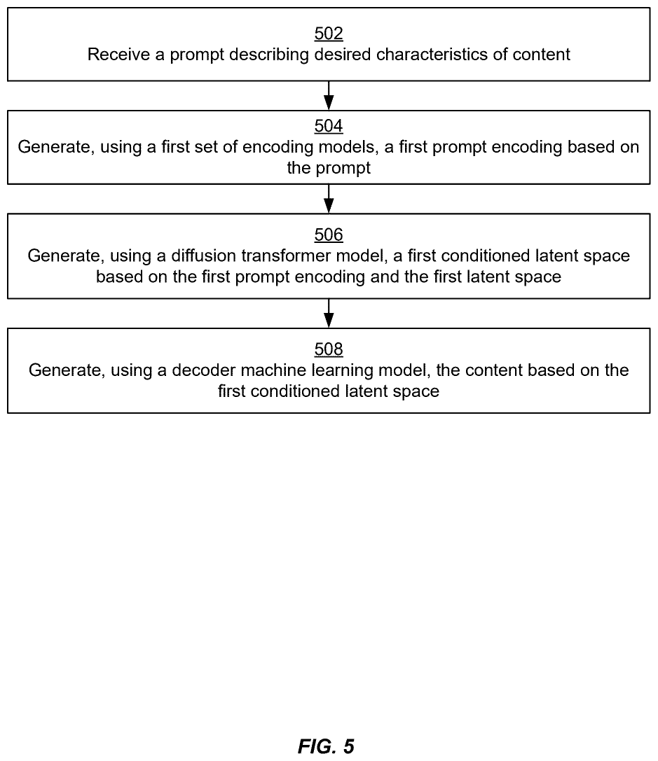

FIG. 5 illustrates an example of a process 500 for using a content

generation system (e.g., content generation system 108 described above), according to embodiments of the present disclosure. The content generation system may include a student model (e.g., second reverse diffusion transformer 318) trained by a teacher model (first reverse diffusion transformer 306), and the student model may be used to generate the content.

At step 502, a prompt (e.g., prompt 208) is received by the content generation system. The prompt may be received from a computing system (e.g., computing system 104). The prompt may describe one or more desired characteristics of content to be generated by the content generation system. For example, the desired characteristics may include a style, a color, a subject, a mood, a texture, a contrast, a depth, a movement, a saturation, a focus, a perspective, a narrative, and/or another characteristic. The prompt may include example content (e.g., images, video), audio, text, images, video. Content in a prompt may be used as inspiration for generating content. The prompt may include content to be added to and/or altered by the content generation system.

At step 504, a first prompt encoding (e.g., prompt conditioning 220) may be generated. The first prompt encoding may be generated by inputting the prompt to a one or more prompt encoding models (e.g., encoding model set 210). Encoding models included in the one or more prompt encoding models may each generate an encoding of at least a portion of the prompt and output the encoding of the portion, which can then be combined with other encodings from encoding models included in the one or more prompt encoding models to generate the first prompt encoding. The one or more encoding models may include one or more text encoders. The one or more encoding models may be used on one or more portions of the prompt. As an example, the one or more encoding models may include a CLIP-G/14 model, a CLIP-L/14 model, and/or a T5 XXL model, etc.

At step 506, a conditioned latent space (e.g., conditioned latent space 226) is generated. The conditioned latent space may be generated by one or more transformer blocks of a diffusion transformer model (e.g., reverse diffusion transformer 224). The transformer blocks may generate the conditioned latent space based at least in part on the first prompt encoding and/or a noisy latent space (e.g., noisy latent space 222), etc. The noisy latent space may have a dimensionality in common with the first prompt encoding.

The first prompt encoding or an encoding derived therefrom may be combined (e.g., added) with an encoding of a timestep to generate a time conditioning signal. The time conditioning signal may include an encoding of a timestep. The conditioned latent space may be generated by the transformer blocks by using the time conditioning signal.

The transformer block(s) may perform reverse diffusion transformations on the first prompt encoding and the noisy latent space. The reverse diffusion operations may be informed by the time conditioning signal. The transformer block(s) may use a joint self attention system to jointly operate on intermediate values respectively generated from the first prompt encoding and the noisy latent space. Output of the joint self attention system may be further operated on in two independent series of operations to generate the conditioned latent space and the second conditioned latent space in respective domains. Independent series of operations performed may use independent weighting (e.g., different weights).

The output from a transformer block may be used as input to a subsequent transformer block. Any number of transformer blocks may be chained together within the reverse diffusion transformer model. The transformer blocks may include a linear layer trained using learnable low-rank (LoRA) matrices. The last block may output the conditioned latent space signal to be transmitted to a decoder model (e.g., decoder model 228). The conditioned latent space signal may include an encoded representation of the content described in the prompt.

At step 508, the decoder model may be used to decode the encoded conditioned latent space representation of the content described in the prompt. The content may include one or more characteristics described in the prompt.

In some embodiments, after the content is generated, a subsequent prompt may be received by the content generation system that causes second content to be generated that is different than the first and that is based on the first prompt and/or the first content. For example, the second prompt may ask that one or more characteristics be added, further emphasized, removed, or changed.

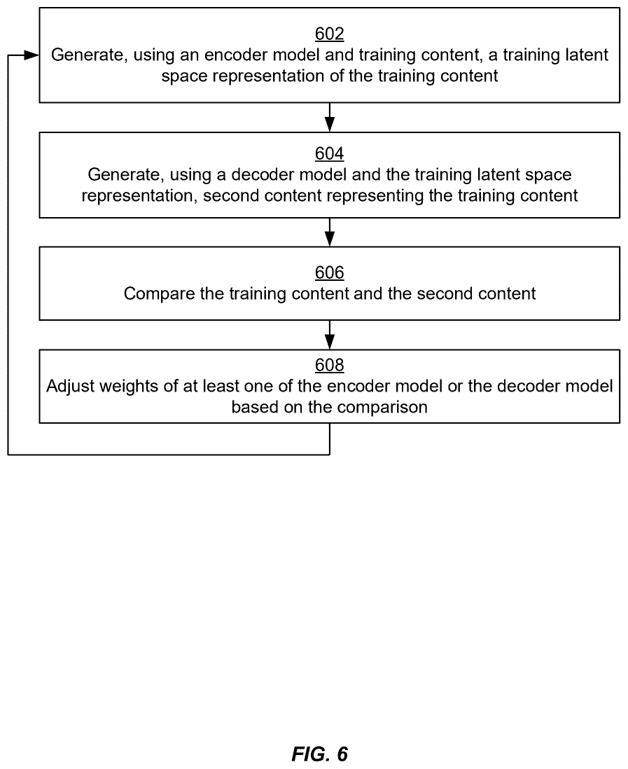

FIG. 6 illustrates an example of a process 600 for training an encoder model (e.g., encoder model 412, a timestep encoding model) and/or a decoder model (e.g., decoder model 228), according to embodiments of the present disclosure. The encoder and/or decoder model may be trained using the system described with respect to FIG. 4, above.

At step S602, an encoder model (e.g., encoder model 412) may receive training content to be used to generate a corresponding training latent space representation of the training content. The training content may be included in training data. The training content and training data has been described above in further detail. In an example, the first training content include content such as images, text, and/or videos, etc. and corresponds to a training prompt.

At step S604, the decoder model may be used to generate the output content using the latent space representation of the training content.

At step S606, the output content generated by the decoder model may be compared (e.g., using an autoencoder adjustment system 408) to the training content input to the encoder model to determine how similar the content is to one another. The comparison may be performed using a loss function (e.g., a reconstruction loss function, a KL divergence loss, an adversarial loss, a perceptual loss). Additionally or alternatively, the comparison may be performed using a discriminator model, each of which have been described in further detail above.

KL divergence loss may be used with Variational Autoencoders (VAEs). KL Divergence loss can be used to measure a difference between a learned latent distribution and a prior distribution (often a standard Gaussian). This encourages the latent space to follow a specific distribution, facilitating better generative capabilities.

Adversarial loss may be used with adversarial autoencoders (AAEs) where a discriminator network is introduced alongside the autoencoder. The adversarial loss is used to make the latent space distribution match a desired prior distribution. This may be akin to the loss used in GANs (Generative Adversarial Networks).

Instead of just pixel-wise reconstruction, perceptual loss compares the high-level features extracted from pre-trained networks (like VGG) between the original and reconstructed images. This can be useful for tasks like super-resolution, where perceptual quality is more important than exact pixel-wise accuracy.

At step S608, the weights of the encoder model and/or the decoder model may be adjusted based on the comparison performed at step S606. The weight adjustment may be performed with the goal of minimizing the loss function or otherwise causing the output content to be more similar to the training content.

Steps S602-S608 may be repeated over a number of training epochs to train or fine tune the decoder model and/or the encoder model. After the decoder model is trained, the trained decoder model may be used during inference time to generate content based on a prompt (e.g., as part of content generation system 108). The weights of the decoder may be frozen after training and before being used during inference time. In some embodiments, after the encoder model is trained using the above process, the encoder model is used during the training process of the diffusion transformer model. The weights of the encoder may be frozen after training and before being used during inference (e.g., while training the diffusion transformer model).

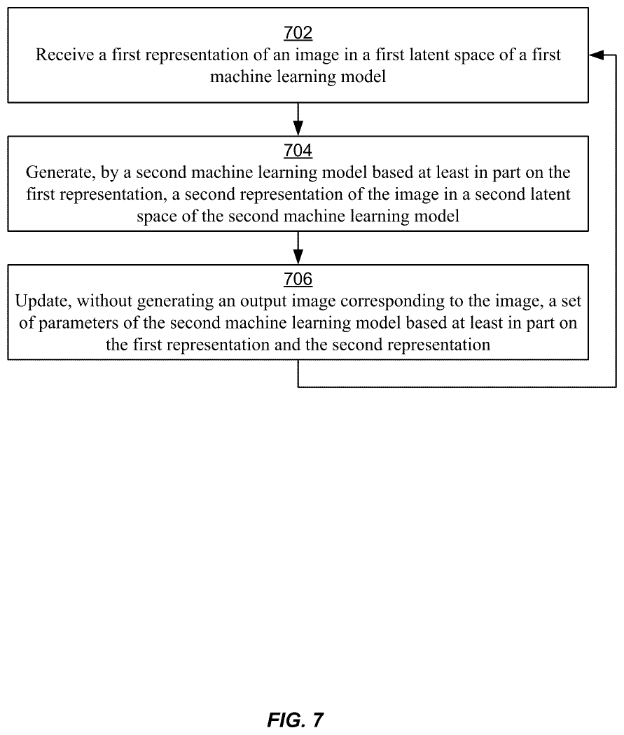

FIG. 7 illustrates an example of a process 700 for training a student reverse diffusion transformer model (e.g., second reverse diffusion transformer 318), according to certain embodiments of the present disclosure.

At S702, a first representation of an image may be received. The first representation may be received by the student reverse diffusion transformer (e.g., second reverse diffusion transformer 318 described above).

The first representation may be received from a teacher reverse diffusion transformer (e.g., first reverse diffusion transformer 306, described above) and the first representation may include a latent space representation of an image (e.g., first latent training content 308, described above). In embodiments where the first representation is received from the teacher reverse diffusion transformer, the first representation may have noise added to it before the performing S704. The first representation may include synthetic latent training data generated by the teacher reverse diffusion transformer.

The first representation may be received from a noise insertion system (e.g., noise insertion system 314, described above) and the first representation may include a latent space representation of the image with added noise (e.g., noisy first latent training content 316, described above). The noise may have been selected from a distribution (e.g., a Gaussian distribution).

The student reverse diffusion transformer may receive a prompt to generate a prompt encoding with. The student reverse diffusion transformer may receive a prompt encoding. The prompt and/or prompt encoding may be a same prompt and/or prompt encoding used to generate the first representation of the image generated by the teacher reverse diffusion transformer model. The prompt and/or prompt encoding may be received from the teacher reverse diffusion transformer or a system that the teacher reverse diffusion transformer received the prompt and/or prompt encoding from.

At S704, the student reverse diffusion transformer may generate a second representation of the image (e.g., second latent training content 320, described above). The student reverse diffusion transformer may generate the second representation based at least in part on the first representation. For example, the student reverse diffusion transformer may denoise the first representation to generate the second representation. The student reverse diffusion transformer may generate the second representation based at least in part on the prompt encoding. The prompt encoding may be used to condition the first representation and to generate the second representation.

The second representation may be further processed so that losses can be determined based at least in part on the second representation. The losses can be determined by a loss comparison system (e.g., loss comparison system 330). The loss comparison system can generate weight adjustment signals (e.g., first weight adjustment signals 338) to be generated. The weight adjustment signals can cause the student reverse diffusion transformer to be updated as described in further detail below with respect to S706.

For example, the second representation may be transmitted to a discriminator model (e.g., discriminator model 336). The discriminator model can use the second representation to predict whether the second representation is real or fake, which can then cause an adversarial loss comparison system (e.g., adversarial loss comparison system 332) to evaluate a loss function and generate weight adjustment signal(s) (e.g., second weight adjustment signals 340, first weight adjustment signals 338) to update the discriminator model and/or the student reverse diffusion transformer. The discriminator model can use the second representation and the first representation of the image to predict whether the second representation is real or fake.

In an example, the second representation may be transmitted to the noise insertion system to add in noise (e.g., the same noise added to the first latent training content to generate the noisy first latent training content), thereby generating a noisy second representation (e.g., noisy second latent training content 324). The noisy second representation can be further processed and used by a distillation loss comparison system (e.g., distillation loss comparison system 334) if the loss comparison system. The noisy second representation can be further processed by the teacher reverse diffusion transformer to generate a denoised latent space that is transmitted to the distillation loss comparison system 334.

At S706, a set of parameter weights of the student reverse diffusion transformer may be updated. The set of parameter weights may be updated based on one or more weight adjustment signals. The parameter weights may be updated without having generated an image from the second representation (e.g., by decoding the second representation into the image). As a result, of not performing any decoding before updating the set of parameter weights, the training process is simplified and training can be performed in the latent space. Training in the latent space can reduce the processing resources, energy resources, network resources, and memory resources used during training of a model since decoding and/or re-encoding need not be performed. Further, the training of the student reverse diffusion transformer enables the student reverse diffusion transformer to be trained such that the student reverse diffusion transformer can generate inference time output similar to the teacher reverse diffusion transformer, but while utilizing less resources during inference time (e.g., because of less sampling steps being performed, less parameters being used).

The process 700 may continue from S706 to S702 any number of times (e.g., epochs) as the training process may be an iterative process. Continuing from S706 to S702 multiple times can cause the student reverse diffusion transformer to become more accurate in generating latent output that is similar (e.g., closer in vector space) to the latent output of the teacher reverse diffusion transformer based on the same prompt encoding, even though the student reverse diffusion transformer may be use less sampling steps than the teacher reverse diffusion transformer and/or occupy less memory space (e.g., because of using less weights).

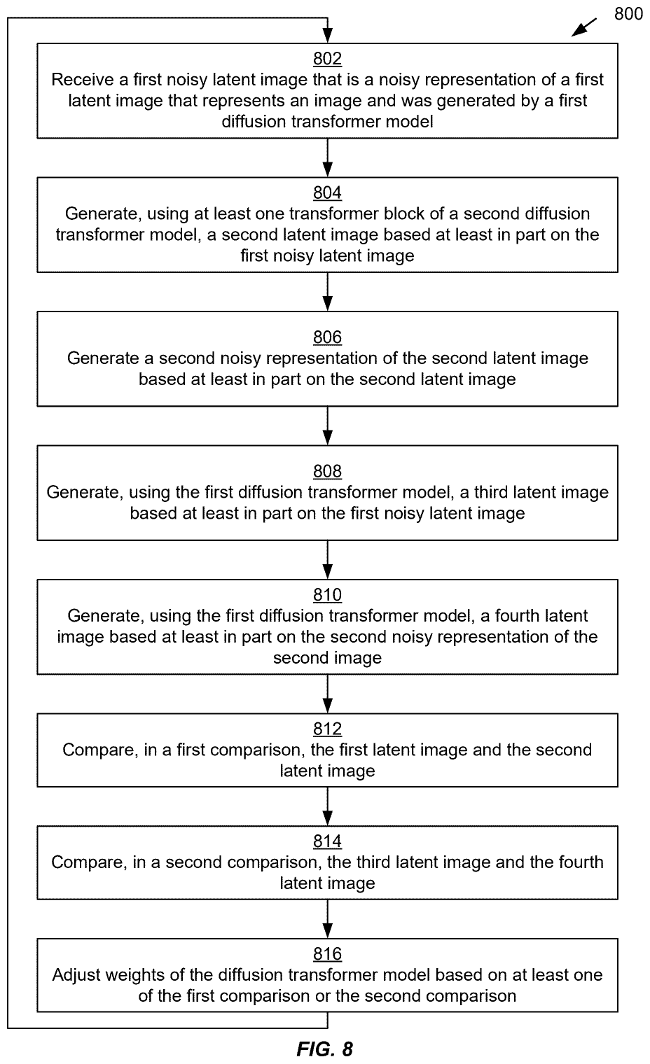

FIG. 8 illustrates an example of a process 800 for training a student diffusion transformer model (e.g., second reverse diffusion transformer 318), according to certain embodiments of the present disclosure. Although the process 800 describes a specific example of an image, other forms of content could also be represented in latent space. For example, instead of an image being represented by the latent space representation, text, a video, code, audio, etc. could be represented by the latent space representation(s) described with respect to process 800 and other FIGS. herein.

At S802, a first noisy latent image (e.g., noisy first latent training content 316) may be received. The noisy first latent training image may be received by the student diffusion transformer model from a noise insertion system (e.g., noise insertion system 314). The noise insertion system may have added noise to a first latent image (e.g., first latent training content 308) generated by a teacher diffusion transformer (e.g., first reverse diffusion transformer 306). The first latent image may represent an image in a latent space.

At S804, the student diffusion transformer may generate a second latent image based at least in part on the first noisy latent image. The student transformer may generate the second latent image using one or more transformer blocks included in the student diffusion transformer. The student diffusion transformer may use less sampling steps than the teacher diffusion transformer. The student diffusion transformer may include less parameters than the teacher diffusion transformer. The second latent image may be equivalent (e.g., equivalent vector value) or close (e.g., in vector space) to the first latent image. The second latent image may be transmitted from the student diffusion transformer to the noise insertion system, described further with respect to S806. The second latent image may be transmitted from the student diffusion transformer to discriminator model (e.g., discriminator model 336).

At S806, the noise insertion system may generate a second noisy representation of the second latent image (e.g., second latent training content 320). The second noisy representation may be generated by adding noise to the second latent image. The noise added to the second latent image may be the same noise added to the first latent image to generate the first noisy latent image.

At S808, the teacher reverse diffusion transformer may receive the first noisy latent image. The first noisy latent image may be received from the noise insertion system. The first noisy latent image may be used by the teacher reverse diffusion transformer to generate a third latent image (e.g., third latent training content 326). The teacher reverse diffusion transformer may use the same prompt encoding that was used by the teacher reverse diffusion transformer to generate the first latent image. The teacher reverse diffusion transformer may use the same prompt encoding that was used by the student reverse diffusion transformer to generate the second latent image from the first noisy latent image. The third latent image may be transmitted to the distillation loss comparison system of the loss comparison system to be compared with a denoised latent image generated using the prompt encoding and/or the second noisy representation.

At S810, the teacher reverse diffusion transformer may receive the second noisy latent image. The second noisy latent image may be received from the noise insertion system. The second noisy latent image may be used by the teacher reverse diffusion transformer to generate a fourth latent image (e.g., fourth latent training content 328). The teacher reverse diffusion transformer may use the same prompt encoding that was used by the teacher reverse diffusion transformer to generate the first latent image. The teacher reverse diffusion transformer may use the same prompt encoding that was used by the student reverse diffusion transformer to generate the second latent image from the first noisy latent image. The fourth latent image may be transmitted to the distillation loss comparison system of the loss comparison system to be compared with a denoised latent image generated using the prompt encoding and/or the first noisy latent image.

At S812, a first comparison may be performed. The first comparison may compare the first latent image and the second latent image to determine how similar they are to one another. The comparison may be performed in vector space. The comparison may be performed by the loss comparison system. Specifically, the comparison can be performed by the adversarial loss comparison system (e.g., adversarial loss comparison system 332, as described above). The comparison may evaluate an adversarial loss function to determine a first weight adjustment signal to transmit to the student reverse diffusion transformer to cause parameters of the student reverse diffusion transformer to be updated. The comparison may evaluate the adversarial loss function to determine a second weight adjustment signal to transmit to the discriminator model to cause parameters of the discriminator model to be updated.

At S814, a second comparison may be performed. The second comparison may compare the third latent image and the fourth latent image to determine how similar they are to one another. The comparison may be performed in vector space. The comparison may be performed by the loss comparison system. Specifically, the comparison can be performed by the distillation loss comparison system (e.g., distillation loss comparison system 334, as described above). The comparison may evaluate a distillation loss function to determine a first weight adjustment signal to transmit to the student reverse diffusion transformer to cause parameters of the student reverse diffusion transformer to be updated.

At S816, the weights of the student diffusion transformer may be updated. The weights may be updated based at least in part on the weight adjustment signals(s) received from the loss comparison system, generates at steps S812 and S814.

The process 800 may continue from S816 to S802 any number of times (e.g., epochs) as the training process may be an iterative process. Continuing from S816 to S802 multiple times can cause the student reverse diffusion transformer to become more accurate in generating latent output that is similar (e.g., closer in vector space) to the latent output of the teacher reverse diffusion transformer based on the same prompt encoding, even though the student reverse diffusion transformer may be use less sampling steps than the teacher reverse diffusion transformer and/or occupy less memory space (e.g., because of using less weights).

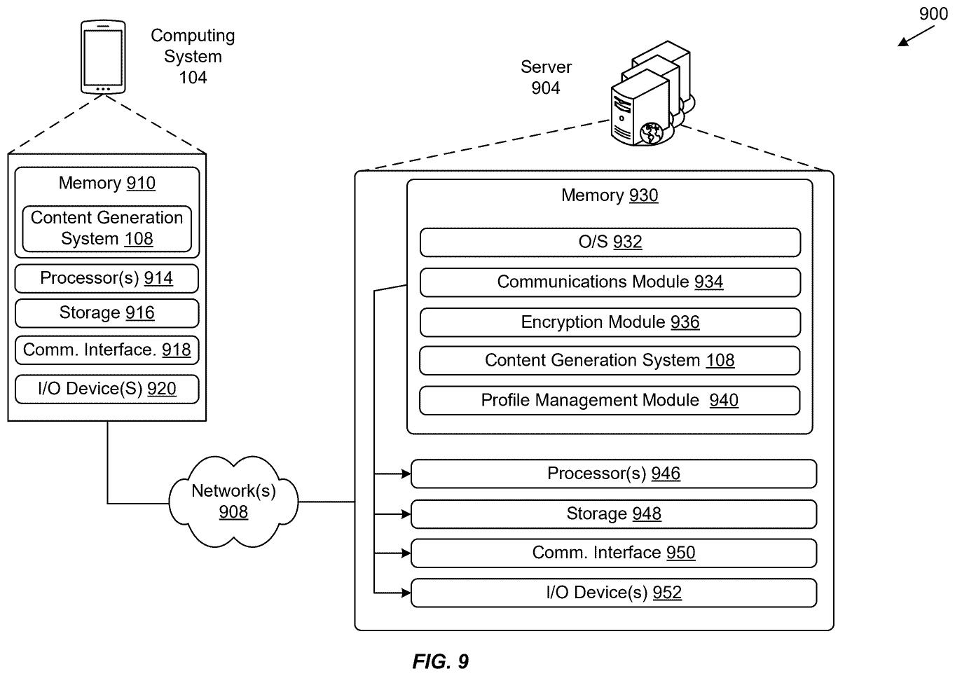

FIG. 9 is a simplified block diagram illustrating an example architecture of a system 900 used to train and/or use the models and systems described herein, according to some embodiments.

The system 900 includes a computing system 104, a network 908, and a server 904. The computing system 104 may be similar to any of the user devices and/or computing systems described herein. The server 904 may correspond to one or more server computers (e.g., a server cluster) of a cloud computing platform, as described herein.

The network 908 may include any suitable communication path or channel such as, for instance, a wire or cable, fiber optics, a telephone line, a cellular link, a radio frequency (RF) link, a WAN or LAN network, the Internet, or any other suitable medium. The network 1008 may include any one or a combination of many different types of networks, such as cable networks, the Internet, wireless networks, cellular networks, and other private and/or public networks. The network may use infrared, ultra-wideband (UWB), Bluetooth (BT), Bluetooth low energy (BTLE), Wi-Fi, and/or radio communication techniques.

Turning to each element in further detail, the computing system 104 may be any suitable computing device (e.g., a mobile phone, tablet, personal computer (PC), smart glasses, a smart watch, etc.). The computing system 104 has at least one memory 910, one or more processing units (or processor(s)) 914, a storage unit 916, a communications interface 918, and an input/output (I/O) device(s) 920.

The processor(s) 914 may be implemented as appropriate in hardware, computer-executable instructions, firmware, or combinations thereof. Computer-executable instruction or firmware implementations of the processor(s) 914 may include computer-executable or machine executable instructions written in any suitable programming language to perform the various functions described.

The memory 910 may store program instructions that are loadable and executable on the processor(s) 914, as well as data generated during the execution of these programs. Depending on the configuration and type of computing system 104, the memory 910 may be volatile (such as random access memory (RAM)) and/or non-volatile (such as read-only memory (ROM), flash memory, etc.). In some implementations, the memory 910 may include multiple different types of memory, such as static random access memory (SRAM), dynamic random access memory (DRAM) or ROM. The computing system 104 may also include additional storage 916, such as either removable storage or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some embodiments, the storage 916 may be utilized to store audio, video, images, and/or text files.

The computing system 104 may also contain the communications interface 918 that allows the user device 902 to communicate with the server, user terminals, and/or other devices on the network(s) 908. The computing system 104 may also include I/O device(s) 920, such as for enabling connection with a keyboard, a mouse, a pen, a voice input device, a touch input device, a display, speakers, a printer, and/or other components the computing system 104 may include.

Turning to the contents of the memory 910 in more detail, the memory 910 may include an operating system and one or more application programs or services for implementing the features disclosed herein, including a content generation system 108 or a system for training one or more of the models used in the content generation system 108.

It should be understood that one or more functions of the content generation system 108 may be performed by the computing system 104 and/or server 904.

In some embodiments, as described above the remote server 904 may correspond to a cloud computing platform. The remote server 904 may perform one or more functions, including, for example: receiving a prompt; generating a first prompt encoding; generating a second prompt encoding; generating a first conditioned latent space and a second conditioned latent space based on the prompt encoding(s) and a first latent space; generating a third conditioned latent space based on the first conditioned latent space and the second conditioned latent space; and/or generating content based on the third conditioned latent space. Remote server 904 may transmit the content to computing system 104. The remote server 904 may include a credential generation module, I/O devices, and/or communications interfaces, etc.

Turning to the contents of the memory 930 in more detail, the memory 930 may include an operating system 932 and one or more application programs or services for implementing the features disclosed herein, including a communications module 934, an encryption module 936, the content generation system 108, and/or a profile management module 940.

The communications module 934 may comprise code that causes the processor 946 to receive prompts, generate embeddings, train models, transmit content, and/or otherwise communicate with other system components. For example, the communications module 934 may receive prompts and transmit content to the computing system 104.

The encryption module 936 may comprise code that causes the processor 946 to encrypt and/or decrypt messages. For example, the encryption module 936 may receive encrypted data (e.g., prompts) from the computing system 104. The encryption module 936 may include any suitable encryption algorithms to encrypt data. Suitable data encryption algorithms may include Data Encryption Standard (DES), tripe DES, Advanced Encryption Standard (AES), etc. It may also store (e.g., in storage unit 948) encryption keys (e.g., encryption and/or decryption keys) that can be used with such encryption algorithms. The encryption module 936 may utilize symmetric or asymmetric encryption techniques to encrypt and/or verify data. For example, the computing system 104 may contain similar code and/or keys as encryption module 936 that is suitable for encrypting/decrypting data communications with the computing system 104 (and/or server 904).

The profile management module 940 may comprise code that causes the processor 946 to maintain and store profiles of users and/or user devices. For example, the profile management module 940 may receive users and/or devices allowed to use the content generation system 108 and/or train the content generation system 108. The profile management module 940 may keep track of users and/or devices associated with prompts and/or generated content so that when the users and/or devices use the server 904 again, the prompts and/or generated content can be transmitted to the users and/or devices (e.g., displayed as content generation history). The profile management module 940 may also include information relating to which users and/or user devices have what permissions, etc.

The processing depicted in FIGS. 5-8 (and/or described with respect to FIGS. 1-4), and any other FIGS. may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented herein are intended to be illustrative and non-limiting. Although FIGS. 5-8, and other FIGS., depict the various processing steps occurring in a particular sequence or order, this is not intended to be limiting. In certain alternative embodiments, the processing may be performed in some different order or some steps may also be performed in parallel. It should be appreciated that in alternative embodiments the processing depicted in FIGS. 5-8, and other FIGS. may include a greater number or a lesser number of steps than those depicted in the respective FIGS.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers, and business application servers. The server(s) also may be capable of executing programs or scripts in response to requests from user devices, such as by executing one or more Web applications that may be implemented as one or more scripts or programs written in any programming language, such as Java®, C, C #, or C++, or any scripting language, such as Perl, Python, or TCL, as well as combinations thereof. The server(s) may also include database servers, including without limitation those commercially available from Oracle®, Microsoft® Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media computer readable media for containing programs/code, or portions of programs/code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an

illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A system comprising:
one or more storage media storing instructions; and
one or more processors configured to execute the instructions to cause the system to:
receive a first representation of an image in a first latent space of a first machine learning model;
generate, by a second machine learning model based at least in part on the first representation, a second representation of the image in a second latent space of the second machine learning model; and
update, without generating an output image corresponding to the image, a set of weights of the second machine learning model based at least in part on the first representation and the second representation.

2. The system of claim 1, wherein the execution of the instructions further causes the system to:
generate a first noisy representation of the first representation by adding first noise to the first representation; and
generate the second representation based at least in part on the first noisy representation.

3. The system of claim 2, wherein the execution of the instructions further causes the system to:
generate a second noisy latent representation of the second representation by adding second noise to the first representation; and
generate the second representation based at least in part on the second noisy representation.

4. The system of claim 3, wherein the first noise and the second noise are the same noise.

5. The system of claim 4, wherein the first noise is selected from a Gaussian distribution.

6. The system of claim 1, wherein the set of weights is updated based at least on using at least one of an adversarial loss comparison or a distillation loss comparison.

7. The system of claim 1, wherein execution of the instructions for updating the set of weights causes the system to:
adjusting a weight included in the set of weights based at least in part on an adjustment value included in a weight adjustment signal received from a loss comparison system that was generated based at least in part on the second representation.

8. The system of claim 1, wherein execution of the instructions for generating the second representation of the image causes the system to:
receive a prompt describing a desired characteristic of the image;
generate, using an encoding model, a prompt encoding based on the prompt; and
generate, using at least one transformer block of the second machine learning model, the second representation based at least in part on the first representation and the prompt encoding.

9. The system of claim 1, wherein the first machine learning model generates the first representation using a first number of steps and the second machine learning model generates the second representation using a second number of steps which is less than the first number of steps.

10. The system of claim 1, wherein execution of the instructions for updating the set of weights causes the system to:
generate a second noisy representation by adding noise to the second representation;
generate a third representation by inputting the second noisy representation to the first machine learning model; and
determine a distillation loss using at least the third representation.

11. The system of claim 10, wherein execution of the instructions for updating the set of weights further causes the system to:
generate a fourth representation by inputting the second noisy representation to the first machine learning model; and
determine the distillation loss using at least the fourth representation.

12. A computer-implemented method comprising:
receiving a first representation of an image in a first latent space of a first machine learning model;
generating, by a second machine learning model based at least in part on the first representation, a second representation of the image in a second latent space of the second machine learning model; and
updating, without generating an output image corresponding to the image, a set of weights of the second machine learning model based at least in part on the first representation and the second representation.

13. The computer-implemented method of claim 12, wherein the first machine learning model is a first diffusion transformer model and the second machine learning model is a second diffusion transformer model.

14. The computer-implemented method of claim 12, wherein the first machine learning model includes frozen weights.

15. The computer-implemented method of claim 12, wherein the set of weights is updated based at least on using an adversarial loss comparison and a distillation loss comparison.

16. The computer-implemented method of claim 12, further comprising:
receiving a prompt describing a desired characteristic of a second image to generate;
generating, using an encoding model, a prompt encoding based at least in part on the prompt;
generating, using at least one transformer block of the second machine learning model, a third representation based at least in part on the prompt encoding; and
generating, using a decoding model, the second image based at least in part on the third representation.

17. One or more non-transitory computer-readable storage media storing instructions that, upon execution executable by one or more processors of a system, cause the system to perform operations comprising:
receiving a first representation of an image in a first latent space of a first machine learning model;
generating, by a second machine learning model based at least in part on the first representation, a second representation of the image in a second latent space of the second machine learning model; and
updating, without generating an output image corresponding to the image, a set of weights of the second machine learning model based at least in part on the first representation and the second representation.

18. The non-transitory computer-readable storage medium of claim 17, wherein the first machine learning model generates the first representation using a first number of sampling steps and the second machine learning model generates the second representation using a second number of sampling steps which is less than the first number of steps.

19. The non-transitory computer-readable storage medium of claim 17, wherein instructions for updating the set of weights cause the system to:
generate a second noisy representation by adding noise to the second representation;
generate a third representation by inputting the second noisy representation to the first machine learning model; and
determine a distillation loss using at least the third representation.

20. The non-transitory computer-readable storage medium of claim 10, wherein instructions for updating the set of weights further cause the system to:
generate a fourth representation by inputting the second noisy representation to the first machine learning model; and
determine the distillation loss using at least the fourth representation.
